(19) United States
(12) Patent Application Publication
(10) Pub. No.: US 2023/0093495 A1
(43) Pub. Date: Mar. 23, 2023

(54) Maintenance Method and Configuration Method for Luminaire Assemblies

(71) Applicant: Schreder S.A., Brussels (BE)

(72) Inventors: Jean Vandeclee, Juprelle (BE); Gérald Olivier, Nivelles (BE); Grégory Dubois, Liége (BE)

(21) Appl. No.: 17/798,835

(22) PCT Filed: Feb. 17, 2021
(86) PCT No.: PCT/EP2021/053879

§ 371 Date: Aug. 10, 2022

(30) Foreign Application Priority Data
Feb. 17, 2020 (NL) 2024923

(51) Int. Cl. H05B 47/19; H05B 47/11

(52) U.S. Cl. CPC H05B 47/19; H05B 47/11

(57) ABSTRACT

Example embodiments relate to maintenance methods and configuration methods for luminaire assemblies. One example maintenance method for replacing a component in a luminaire assembly includes obtaining desired operational information of the luminaire assembly. The method also includes obtaining identification information of a replacement programmable component. Additionally, the method includes creating a feature file based on the desired operational information and the component identification information. The feature file includes programming instructions for programming the replacement programmable component to obtain the desired operation as defined by the desired operational information. Further, the method includes replacing the previous component by the replacement programmable component. In addition, the method includes configuring the replacement programmable component using the created feature file.

### FIELD OF INVENTION

The invention relates to a maintenance method and a configuration method for luminaire assemblies, in particular outdoor luminaire assemblies, comprising programmable components such as programmable drivers.

### BACKGROUND

During the lifecycle of a luminaire assembly, the driver inside the assembly may need to be replaced due to obsolescence or failure. The replacement of the driver is yet a cumbersome process. A user, generally a maintenance professional, needs to physically replace the old and/or failed part by a replacement driver, which needs to be programmed to fulfil the same requirements as its predecessor in terms of lighting, protection and other properties. As nowadays most drivers, especially for outdoor luminaire assemblies, are programmable, the user is faced with selecting a suitable replacement driver and programming it with the old specifications. Usually this means entering all the desired operational characteristics by hand in a software interface designed for programming the specific driver concerned. As every driver producer has a unique software interface for his own products, and multiple drivers of multiple brands may be suitable for the same use, the maintenance of the luminaire assemblies and the configuration of the luminaire assemblies is a time-consuming and costly process.

Same issues may arise for other programmable components of a luminaire such as controllers, sensors, communication devices to name a few.

### SUMMARY

The object of embodiments of the invention is to provide an efficient, versatile and easy to use maintenance method and configuration method for luminaire assemblies. More in particular, it is desirable to be able to use the method in combination with a large number of brands, models of programmable components such as drivers and types of applications.

According to a first aspect of the invention, there is provided a maintenance method for replacing a driver in a luminaire assembly, said method comprising:
obtaining desired dimming information of the luminaire assembly,
obtaining identification information of a replacement programmable driver,
creating a feature file based on the desired dimming information and the driver identification information, said feature file comprising programming instructions for programming the replacement programmable driver to obtain the desired dimming as defined by the desired dimming information,
replacing the previous driver by the replacement programmable driver,
configuring the replacement driver using the created feature file.

In this way, maintenance is simplified and automated on the basis of only two input data for various drivers and lighting applications rendering the maintenance method efficient, versatile and easy to use. The step of replacing the previous driver by a replacement driver may be split in two steps of first removing the previous driver and second installing the replacement driver. In addition these two steps may be performed prior or after any of the other steps of the above mentioned method depending on circumstances and as obvious to a skilled person. For instance a maintenance specialist may first remove the old driver in the luminaire, program the replacement driver (new driver) on the ground and then install the new driver in the luminaire, or remove the old one, install the new one and then program the new one among other possibilities. According to another example one could even first program the new driver, then remove the old driver and next install the new one.

Preferred embodiments relate to methods for performing maintenance on outdoor luminaire assemblies. By outdoor luminaire, it is meant luminaires which are installed on roads, tunnels, industrial plants, stadiums, airports, harbours, rail stations, campuses, parks, cycle paths, pedestrian paths or in pedestrian zones, for example, and which can be used notably for the lighting of an outdoor area, such as roads and residential areas in the public domain, private parking areas, access roads to private building infrastructures, etc.

According to another aspect there is provided a maintenance method for replacing a component in a luminaire assembly, said method comprising: obtaining desired operational information of the luminaire assembly; obtaining identification information of a replacement programmable component; creating a feature file based on the desired operational information and the component identification information, said feature file comprising programming instructions for programming the replacement programmable component to obtain the desired operation as defined by the desired operational information; replacing the previous component by the replacement programmable component; configuring the replacement programmable component using the created feature file.

Thus, where in some embodiments the component may be a driver for powering a light source, in other embodiments, the component may be e.g. a sensor such as an environmental sensor, a communications means, a controller such as a pluggable control module, a driver for powering a load which is not a light source (the load could be e.g. a sensor or a controller or a communication means or a movement means), etc. Note that the controller may be configured for controlling any type of component of the luminaire assembly, e.g. a controller for controlling the driver and/or one or more sensors and/or any other electrical or mechanical device of the luminaire assembly.

When a driver is a driver for driving a light source in function of a dimming signal, the operational information typically comprises dimming information. However, for other programmable components, other operational information may be used. In the following paragraphs, first an exemplary embodiment where the operational information comprises dimming information is discussed and next other exemplary embodiments are discussed.

According to a preferred embodiment, the desired dimming information is defined by a dimming code representative for at least a drive current and a type of dimming The drive current is the maximum output current used to drive a light source, typically a plurality of LEDs of the luminaire assembly. The type of dimming can be e.g. amplitude dimming relating a voltage to the light output, scheduling dimming where several dimming levels are scheduled during the day, DALI, Bipower mode having two dimming levels, 0-10V, no dimming mode where the user chooses to operate without dimming, etc. In this way the user only enters one simple code while coding multiple information and the risks of introducing an error at that stage of the maintenance method are mitigated. Preferably the dimming code is further representative for at least an additional parameter selected from: a dimming profile over time, a thermal protection feature and a constant lumen output (CLO) feature, a geographical information, additional functionalities information. For example, the dimming code may indicate whether a thermal protection for protecting the LEDs from overheating is present, whether a CLO function is present, a type of CLO defined by a value of a start current in percentage and a maximum amount of time before full current, a dimming percentage in function of the time of the day, a dimming percentage in function of a sensed value (e.g. sensed light, sensed movement, etc.), dimming current levels and dimming starting times for scheduling dimming, an initial dimming level, a daylight saving time, a midnight shift information based on a country code, a time zone information, a latitude information, a longitude information, a time base dimming information relating the time elapsed and the light output, a sensor override information for overriding a photocell sensor on the basis of another information like the presence of a user, a light colour temperature output, etc. The interest of a dimming code increases as the number of use parameters increases. In this way the maintenance method is rendered more time-efficient for a user and more reliable as this method inherently brings fewer risks of errors.

According to a preferred embodiment, where the component is a driver, the identification information is defined by a driver code representative for the technical characteristics of the driver. For example, the identification code may define the name and/or brand and/or model of the driver. In this way the unique characteristics of the replacement driver may be taken into account during the maintenance. Note that the driver may be for powering a light source and/or for powering a load which is not a light source (the load could be e.g. a sensor and/or a controller and/or a communication means and/or a movement means).

According to an exemplary embodiment, the step of creating a feature file based on the desired operational information and the identification information comprises the step of using a mapping table between the operational information and programming parameters of the programmable component defined by the identification information. In this manner the desired operational information for the luminaire assembly may be translated into a language specific to a specific programmable component.

According to a preferred embodiment, the step of creating a feature file based on the desired dimming information and the identification information comprises the step of using a mapping table between the operational information including the dimming information and programming parameters of programmable drivers defined by their respective identification information. In this manner the desired dimming information and optionally other operational information for the luminaire assembly are translated into a language specific to a specific driver.

According to a preferred embodiment, the method further comprises the additional step of verifying the compatibility between the identification information and the desired operational information. In this way a safeguard against an improper matching between the intended use and the chosen replacement component is introduced. The reliability of the maintenance is as a consequence increased, as this step insures that the selected replacement component will be able to perform the desired operation as defined by the operational information. For example, a determined protocol may be used by the luminaire assembly for communicating with the component, in which case it may be checked whether the programmable replacement component supports the same determined protocol. In another example, where the component is a sensor, the operation of the luminaire assembly may require the sensor to have a minimal resolution, in which case it may be checked whether the programmable replacement sensor corresponding with the identification information has the required minimum resolution.

According to a preferred embodiment, the method further comprises the additional step of verifying the compatibility between the identification information of the driver and the desired dimming information. In this way a safeguard against an improper matching between the intended use and the chosen replacement driver is introduced. The reliability of the maintenance is as a consequence increased, as this step insures that the selected replacement driver will be able to perform the desired dimming as defined by the dimming information. An improper matching is detected by comparing for instance the dimming information and minimum and maximum values of parameters accepted by the driver corresponding to the identification information. Additionally or alternatively the availability of the dimming type or any other additional parameter of the dimming information is verified for the driver corresponding to the identification information. For example, if the type of dimming of the desired dimming information is DALI, it is checked if the driver supports DALI. If the driver only supports 1-10V, the incompatibility between the identification information and the desired dimming information is indicated.

Preferably, the creating of the feature file is done by a computer means based on the identification information and the operation information, e.g. the dimming information. The computer means may be a mobile device such as a tablet, a smart phone or a laptop. Alternatively the computer means may be a remote server with communication means such that the creation of the feature file may be done remotely and transmitted to a mobile device connectable to the driver. Preferably the remote server is a cloud converter connectable via a mobile phone application. Optionally, a user transmits the feature file from his mobile phone to the programmable component, e.g. the driver, via the same or a different application and optionally using a specific interface. Optionally, a brand-specific mobile phone application with secure transfer transmits the feature file obtained from the cloud to the programmable component, e.g. the driver. In a possible embodiment, the created feature file is transferred from a first mobile device, e.g. a smart phone, to a second mobile device, e.g. a brand-specific mobile device, and next from the second mobile device to the programmable component. The transfer to the second mobile device may use a first protocol, e.g. Bluetooth, and the transfer from the second mobile device to the component, e.g. the driver, may use a second protocol, e.g. NFC. Such an embodiment may be useful if the first mobile device is not capable of communicating using the second protocol and/or for security reasons.

According to an exemplary embodiment, the feature file may be encrypted by the computer means. For example, the feature file may be created on a remote server and encrypted before sending it to a mobile device. Alternatively, it may be created and encrypted on the mobile device, optionally using information received from the remote server. The decryption may e.g. take place in the mobile device, in the programmable component or in a further mobile device as described above.

According to a preferred embodiment, the step of obtaining the identification information comprises reading the identification information of the replacement component, e.g. the driver, using near field communication (NFC). In this way a universal, time-efficient and error free step of retrieving the identification information is offered. Alternatively, obtaining the identification information comprises entering the identification information by an operator in a computer means such as a tablet. For example, the identification information may be selected from a selection menu displaying a list of various drivers or other programmable components of different brands and models types or may be typed by a user reading information labelled on the programmable component, e.g. the driver. This option allows the use of programmable components such as drivers not provided with NFC or other automated communication means. Alternatively, obtaining the identification information comprises machine reading a QR code or a bar code on the programmable component, e.g. the replacement driver. Again this option as NFC offers a time-efficient and error free solution. Other options may further be used, like wired (e.g. DALI, 1-10V), or wireless transfer (e.g. using Bluetooth) of the identification information between the replacement programmable component, e.g. the driver, and the computer means used to execute the method.

According to a preferred embodiment, obtaining the desired operational information, e g dimming information, of the luminaire assembly comprises reading the operational information using near field communication (NFC). For example, the operational information, e g dimming information, may be stored within the luminaire assembly, e.g. in the driver, or in the luminaire comprising a dedicated memory or in a controller for communicating with a remote server comprising a memory. In this way a time-efficient and error free step for retrieving the operational information, e.g. dimming information is realised. Alternatively, obtaining the desired operational information, e.g. dimming information, of the luminaire assembly comprises entering the operational information, e.g. dimming information, by an operator. For example, the dimming information may be selected from a selection menu displaying a list of various dimming information or may be typed by a user, based on information labelled on the defective component, e.g. the defective driver, or on the luminaire The user may also retrieve the information from the maintenance history. This option allows dealing with defective NFC component, e.g. defective NFC drivers, or with luminaire assemblies not provided with NFC or other automated communication means. Again other options may further be used like for instance the use of QR codes or barcodes on the luminaire assembly, or on the defective component, e.g. the defective driver, or the use of wired or wireless transfer of the desired operational information between the luminaire assembly, or the defective driver or a controller for remote communication and the computer means used to execute the method. In some embodiments, a bar code or other identification means on the luminaire may be a way to identify the luminaire and a remote server may store the operational information, e.g. dimming information, for this luminaire, wherein the computer means obtain the operational information from the remote server based on the bar code or other identification means on the luminaire.

According to a preferred embodiment, the step of configuring the replacement programmable component, e.g. the replacement driver, using the created feature file comprises transferring the feature file to the replacement programmable component, e.g. the replacement driver, using near field Communication (NFC). In this way the maintenance is even more time-efficient. Alternatively other options may be used like wired or wireless transfer (e.g. using Bluetooth or another short range protocol). Preferably a brand specific interface with secure transfer transfers the created feature file to the replacement component, e.g. the replacement driver, using brand specific communication means.

According to an exemplary embodiment, the step of configuring the replacement programmable component, using the created feature file comprises transferring the created feature file using a first protocol, e.g. Bluetooth, to a transfer device, e.g. a brand-specific transfer device, and transferring the created feature file using a second protocol, e.g. NFC, different from the first protocol, from the transfer device to the programmable component. For example, the feature file may be created e.g. on a mobile device or on a remote server communicating with the mobile device and the mobile device may transfer the feature file to the transfer device using the first protocol.

According to an exemplary embodiment, the method further comprises a step of encrypting the created feature file, transferring the encrypted feature file and decrypting the encrypted feature file. Preferably, the decrypting is done in the programmable component or in the transfer device.

According to an exemplary embodiment, the programmable component is any one of the following: a controller, a sensor, a communication device, a human-interface device. For example, the sensor may be an environmental sensor such as a motion sensor, a pollution sensor, an image sensor such as a camera, a radar sensor, a microphone, a detector of CO2, NOx, smoke, etc. The human interface device (HID) may be e.g. a button, such as a panic button, a touch screen, a microphone. The communication device may comprise any one or more of the following: telecommunication circuitry, such as an antenna, WiFi circuitry, repeater circuitry, e.g. a WiFi repeater, etc. Also other programmable components are possible such as charger circuitry, e.g. phone charger circuitry or vehicle charger circuitry; a socket, such as an electrical socket.

The controller may be e.g. a controller intended to be mounted inside a luminaire housing or a pluggable control module intended to be plugged in a socket receptacle provided to the luminaire housing. For example, the socket receptacle is one of a NEMA or Zhaga socket receptacle, and the pluggable control module is a module configured to be plugged in such socket receptacle, e.g. as described in ANSI C136.10-2017 standard or ANSI C136.41-2013 standard or Zhaga Interface Specification Standard (Book 18, Edition 1.0, July 2018, see https://www.zhagastandard.org/data/downloadables/1/0/8/1/book_18.pdf or Book 20: Smart interface between indoor luminaires and sensing/communication modules), which are included herein by reference.

According to an exemplary embodiment, the desired operational information comprises any one or more of the following: a dimming information, a protocol type, e.g. a type of communication protocol used by the programmable component, a power related parameter, a control parameter, a control profile.

In an exemplary embodiment the programmable component is a programmable sensor having a memory in which one or more control parameters are stored, e.g. during assembly of the luminaire in the factory, wherein the one or more control parameters are ensuring a good operation of the sensor within the luminaire assembly. For example, the one or more control parameters may be set to take into account the installation height of the sensor and/or the desired detection area of the sensor (e.g. size of the detection area, position of the detection area, etc.) and/or the resolution of the sensor, etc. The one or more control parameters may control a digital adjustment and/or a mechanical adjustment of the sensor. For example, the sensor could be configured to monitor multiple zones, and one or more control parameters may set which zones have to be activated and/or which zones have to be deactivated. Another example of a control parameter could be a time period during which a light source of the luminaire assembly should be switched on or during which an intensity of the light source should be changed (e.g. increased), upon detection of a predetermined situation by the sensor. The predetermined situation may be e.g. the detection of an object with predetermined properties (e.g. size related and/or speed related), the detection of a predetermined traffic related property (e.g. an amount of cars per minute being above a predetermined threshold), the detection of a weather-related property (e.g. visibility below a predetermined threshold), etc. Yet other control parameters may relate to properties of objects to be detected by the sensor (e.g. car, bicycle, pedestrian), the sense and/or orientation of moving objects to be detected, etc.

When such programmable sensor is to be replaced, the operational information may comprise the one or more control parameters, and the created feature file may be such that the same or similar values are set for one or more control parameters of the programmable replacement sensor. In such an exemplary embodiment, the programming of the sensor could be done in a wireless manner, e.g. by Bluetooth or NFC as explained above, or in a wired manner, e.g. by DALI.

According to a further aspect, there is provided a computer-implemented method for configuring a luminaire assembly comprising a programmable driver, comprising:
obtaining desired dimming information of the luminaire assembly,
obtaining identification information of the programmable driver,
creating a feature file based on the desired dimming information and the identification information, said file comprising programming instructions for programming the programmable driver to obtain the desired dimming as defined by the desired dimming information,
configuring the driver using the created feature file.

In this way, the configuration is simplified, automated on the basis of only two input data for all various drivers and lighting applications rendering the maintenance method efficient, versatile and easy to use.

According to another aspect there is provided a computer-implemented method for configuring a luminaire assembly comprising a programmable component, comprising: obtaining a desired operational information for the luminaire assembly, obtaining the identification information of the programmable component, creating a feature file based on the desired operational information and the identification information, said file comprising programming instructions for programming the programmable component to obtain the desired operation defined by the desired operational information, configuring the programmable component using the created feature file.

Thus, where in some embodiments of the computer-implemented method, the programmable component may be a driver for powering a light source, in other embodiments, the component may be e.g. a sensor, a communications means, a controller, a driver for powering a load which is not a light source, a human interface device, etc.

When a driver is a driver for driving a light source in function of a dimming signal, the operational information typically comprises dimming information. However, for other programmable components, other operational information may be used as has been explained above. In the following paragraphs an exemplary embodiment where the operational information comprises dimming information is discussed, but the examples provided above for other programmable components and other operational information apply mutatis mutandis for the computer-implemented method.

Preferred embodiments relate to methods for configuring outdoor luminaire assemblies. By outdoor luminaire, it is meant luminaires which are installed on roads, tunnels, industrial plants, stadiums, airports, harbours, rail stations, campuses, parks, cycle paths, pedestrian paths or in pedestrian zones, for example, and which can be used notably for the lighting of an outdoor area, such as roads and residential areas in the public domain, private parking areas, access roads to private building infrastructures, etc.

According to a preferred embodiment, the desired dimming information is defined by a dimming code representative for at least a drive current and a type of dimming The drive current is the maximum output current used to drive a light source, typically a plurality of LEDs of the luminaire assembly. The type of dimming can be e.g. amplitude dimming relating a voltage to the light output, scheduling dimming where several dimming levels are scheduled during the day, DALI, Bipower mode having two dimming levels, 0-10V, no dimming mode where the user chooses to operate without dimming, etc. In this way the user only enters one simple code while coding multiple information and the risks of introducing an error at that stage of the maintenance method are mitigated. Preferably the dimming code is further representative for at least an additional parameter selected from: a dimming profile over time, a thermal protection feature and a constant lumen output (CLO) feature, a geographical information, additional functionalities information. For example, the dimming code may indicate whether a thermal protection for protecting the LEDs from overheating is present, whether a CLO function is present, a type of CLO defined by a value of a start current in percentage and a maximum amount of time before full current, a dimming percentage in function of the time of the day, a dimming percentage in function of a sensed value (e.g. sensed light, sensed movement, etc.), dimming current levels and dimming starting times for scheduling dimming, an initial dimming level, a daylight saving time, a midnight shift information based on a country code, a time zone information, a latitude information, a longitude information, a time base dimming information relating the time elapsed and the light output, a sensor override information for overriding a normal operation on the basis of a sensed information like the presence of a user, a light colour temperature output, etc. In this way the configuration method is rendered more time-efficient for a user and more reliable as this method inherently brings fewer risks of errors.

According to a preferred embodiment, the identification information is defined by a driver code representative for the technical characteristics of the driver. For example, the identification code may define the name and/or brand and/or model of the driver. In this way the unique characteristics of the driver may be taken into account during the configuration.

According to a preferred embodiment, the step of creating a feature file based on the desired dimming information and the identification information comprises the step of using a mapping table between the dimming information and programming parameters of programmable drivers defined by their respective identification information. In this manner the desired dimming information for the luminaire assembly are translated into a language specific to a specific driver.

According to a preferred embodiment, the method further comprises the additional step of verifying the compatibility between the identification information of the driver and the dimming information. In this way a safeguard against an improper matching between the intended use and the driver is introduced. The reliability of the configuration is as a consequence increased, as this step insures that the driver will be able to perform the desired dimming as defined by the dimming information. An improper matching is detected by comparing for instance the dimming information and minimum and maximum values of parameters accepted by the driver corresponding to the identification information. Additionally or alternatively the availability of the type of dimming or any other additional parameter of the dimming information is verified for the driver corresponding to the identification information.

Preferably, the creating of the feature file is done by a computer means based on the identification information and the dimming information. The computer means may be a mobile device such as a tablet or a smart phone or a laptop. Alternatively the computer means may be a remote server with communication means such that the creation of the feature file may be done remotely and transmitted to a mobile device. Preferably the remote server is a cloud converter connectable via a mobile phone application. Optionally, a user transmits the feature file from his mobile phone via the same or a different application and optionally using a specific interface. Optionally, a brand-specific mobile phone application with secure transfer transmits the feature file obtained from the cloud to the driver.

According to a preferred embodiment, the step of obtaining the identification information comprises reading the identification information on the driver using near field communication (NFC). In this way a universal, time-efficient and error free step of retrieving the identification information is offered. Alternatively obtaining the identification information comprises entering the identification information by an operator in a computer means such as a tablet. For example, the identification information may be selected from a selection menu displaying a list of various drivers of different brands and models types or may be typed by a user reading information labelled on the driver. This option allows the use of drivers not provided with NFC or other automated communication means. Alternatively, obtaining the identification information comprises machine reading a QR code or a bar code on the replacement driver. Again this option as NFC offers a time-efficient and error free solution. Other options may further be used, like wired or wireless transfer of the identification information between the replacement driver and the computer means used to execute the method.

According to a preferred embodiment, obtaining the desired dimming information of the luminaire assembly comprises reading the dimming information using near field communication (NFC). For example, the dimming information may be stored within the luminaire assembly, e.g. in the driver, or in the luminaire comprising a dedicated memory or in a controller for communicating with a remote server comprising a memory. In this way a time-efficient and error free step for retrieving the dimming profile is realised. Alternatively, obtaining the desired dimming information of the luminaire assembly comprises entering the dimming information by an operator. For example, the dimming information may be selected from a selection menu displaying a list of various dimming information or may be typed by a user, based on information labelled on the defective driver or on the luminaire. The user may also retrieve the information from the maintenance history. This option allows to deal with drivers not provided with NFC or other automated communication means. Again other options may further be used like for instance the use of QR codes or barcodes on the luminaire assembly, on the driver or wired or wireless transfer of the desired dimming information between the luminaire assembly, or the driver or a controller for remote communication and the computing means to execute the method.

According to a preferred embodiment, the step of configuring the driver using the created feature file comprises transferring the feature file to the driver using near field communication (NFC). In this way the maintenance is even more time-efficient. Alternatively other options may be used like transfer via cables or wireless transfer (e.g. using Bluetooth or another short range protocol). Preferably a brand specific interface with secure transfer transfers the created feature file to the replacement driver using brand specific communication means.

According to another aspect, a computer program comprises instructions to cause computing means to execute the steps of any one of the above embodiments of the methods of any one of the previous aspects.

According to another aspect, a computer readable medium has stored thereon the above described computer program.

According to another aspect, there is provided a system for a luminaire assembly, said system comprising a programmable component, e.g. a programmable driver, for use in said luminaire assembly, and computer means adapted to execute the steps of the methods of any one of the previous aspects. Preferably, the computer means comprise an NFC peripheral interface arranged to read the identification information and/or to transfer the feature file to the component, e.g. the driver. Preferably, the computer means is provided with a user interface for entering information. For example, the computer means may be a mobile computer device such as a tablet, a smart phone or a laptop. Alternatively the computer means may be a remote server with communication means such that the creation of the feature file may be done remotely and transmitted to a mobile device.

### BRIEF DESCRIPTION OF THE FIGURES

This and other aspects of the present invention will now be described in more detail, with reference to the appended drawings showing currently preferred embodiments of the invention. Like numbers refer to like features throughout the drawings

FIG. 1 is a schematic drawing of a maintenance situation illustrating an exemplary embodiment of the maintenance method.

FIG. 2 is a schematic drawing of a configuration situation illustrating an exemplary embodiment of the method for configuring a luminaire.

FIG. 3 shows a flowchart illustrating an exemplary embodiment of the maintenance method for replacing a driver in a luminaire.

FIGS. 4A to 4D show schematic screen views of an exemplary embodiment of a program for executing the maintenance and configuration methods.

FIG. 5 shows a flowchart illustrating an exemplary embodiment of the method for configuring a luminaire.

FIGS. 6A and 6B show schematic views of further exemplary embodiments of the method.

### DESCRIPTION OF THE EMBODIMENTS

FIG. 1 shows a maintenance situation in which an exemplary embodiment of the maintenance method is of particular interest. In particular, a system 1000 comprises a replacement driver 100 and computing means 30 for interacting with the replacement driver 100 and/or a driver 10 to be replaced and/or other parts of a luminaire 1. A maintenance specialist 20 comes to service a luminaire 1 comprising a driver 10 to be replaced due to obsolescence or failure. The case of a failure will be taken as hypothesis in the rest of the description as way of an example only. The maintenance specialist brings with him spare parts 100, 200, 300 . . . and computing means 30 with several peripherals 40, 50 and 60. Among the possible peripherals could be an NFC peripheral interface 40, a cabling interface 50 to interact with drivers via physical wiring and plugging, a bar code reading interface, a tablet or a mobile 60 for scanning QR codes. The computing means self may be comprised in a general computer, a laptop, a tablet, a mobile or a remote server. This list is not exclusive and is a mere illustration of possibilities a skilled person would understand as suitable for the present application. The spare parts 100, 200, 300, etc. are the new drivers for luminaire assemblies at the disposition of the maintenance specialist. They may be of different brands and/or different models. In practice drivers of different brands may support similar lighting situations and a skilled person, like a maintenance specialist, would know which of the spare parts at his disposal could possibly be used as replacement of the driver 10.

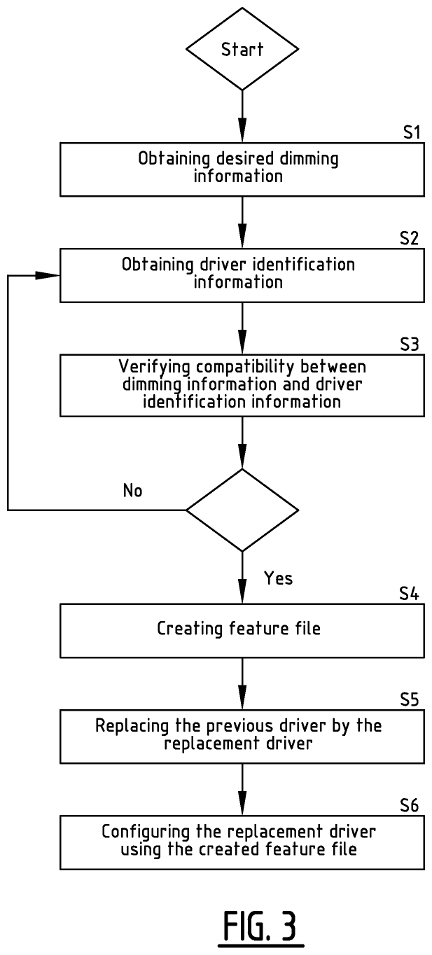

The maintenance method for replacing a driver in a luminaire in that situation will now be described with reference to the flowchart of FIG. 3. The method is in part computer-implemented on the computing means 30 connected to peripheral interfaces 40, 50 and 60.

Upon starting the maintenance, the first step Si is to obtain the desired dimming information of the luminaire assembly. The dimming information may be defined by a dimming code representative for at least a drive current and a type of dimming For instance the dimming code may stand for a feature table comprising at least a drive current and a type of dimming for simple cases. The drive current may be the maximum output current used to drive a light source, typically a plurality of LEDs of the luminaire assembly. The type of dimming can be e.g. amplitude dimming relating a voltage to the light output, scheduling dimming where several dimming levels are scheduled during the day, DALI, Bipower mode having two dimming levels, 0-10V, no dimming mode where the user chooses to operate without dimming, etc. The dimming code may further be representative for at least an additional parameter selected from: a dimming information, such as a dimming profile over time, a thermal protection feature and a constant lumen output (CLO) feature, a geographical information, further functionalities information. For example, the dimming code may indicate whether a thermal protection for protecting the LEDs from overheating is present, whether a CLO function is present, a type of CLO defined by a value of a start current in percentage and a maximum amount of time before full current, a dimming percentage in function of the time of the day, a dimming percentage in function of a sensed value (e.g. sensed light, sensed movement, etc.), dimming current levels and dimming starting times for scheduling dimming, an initial dimming level, a daylight saving time, a midnight shift information based on a country code, a time zone information, a latitude information, a longitude information, a time base dimming information relating the time elapsed and the light output, a sensor override information for overriding a photocell sensor on the basis of another information like the presence of a user, a light colour temperature output, etc. By desired dimming information is referred to information related to the future dimming characteristics intended for the luminaire in terms at least of drive current and type of dimming. In most maintenance cases, the future dimming characteristics as defined by the desired dimming information will be the same as the past dimming characteristics of the luminaire prior to the failure of the driver. In other cases, the future dimming characteristics may contain new dimming characteristics of the luminaire related to an upgrade or a downgrade of the luminaire.

Optionally, the dimming information may be retrieved from the driver to be replaced. The dimming information may be for instance read via QR code or a bar code on the defective driver or on the luminaire. A mobile 50 or a tablet transmits then to the computing means 30 the data concerning the dimming profile. The diming information may also be known from beforehand and manually entered in the form of a code of a limited number of digits by the maintenance specialist. During step S1, data concerning the desired dimming information is thus received.

The following step S2 is to obtain the identification information concerning a replacement programmable driver. By replacement driver is meant the new driver, as example here for the rest of the description the driver 100, intended to be used in the luminaire instead of the old and/or faulty driver 10. The identification information may be actually defined by a driver code representative for the technical characteristics of the driver, preferably the name and/or brand and/or model of the driver. The maintenance specialist 20 may use here his knowledge in selecting already one probably compatible driver: by selecting either the same driver (same brand same model) as previously or another driver (different brand and/or model) suitable for the dimming profile identified in Step S1. The step of obtaining the identification information is done preferably by reading the driver identification code by NFC on the replacement driver 100. The NFC peripheral interface 40 reads into the replacement driver 100 and transmits to the computing means 30 the data concerning the driver identification code of the replacement driver 100. During step S2, data concerning the identification information in the form of a driver identification code is thus received.

However the maintenance specialist may not know for sure which driver would be compatible or may unintentionally select a wrong driver. To cope with such issues, the next step S3 is to verify the compatibility between the identification information and the dimming information. In this way a safeguard against an improper matching between the intended use and the chosen replacement driver is introduced. In case the result of the compatibility check is negative, an error message indicating an incompatibility is shown to the user and the method loops back to step S2 by requesting new identification information of another driver. Other ways of communicating the error may be selected depending on circumstances, by for instance other visual or audio means. As an example of incompatibility, one can think of the situation where a certain selected driver does not support the option of thermal protection of the LEDs while the selected dimming code is representative of the presence of such a thermal protection, the combination selected driver/selected dimming information would then be incompatible. If the result of the compatibility test is positive and the dimming information and identification information are compatible, the method proceeds further to step 4.

The following step S4 is then to create a feature file based on the desired dimming information and the identification information. The feature file comprises programming instructions for programming the replacement programmable driver to obtain the desired dimming as defined by the desired dimming information. A mapping table may be used between the dimming information and the programming parameters of programmable drivers defined by their respective identification information. In this manner, the desired dimming information for the luminaire assembly may be translated into a language specific to a specific driver, and can be used to generate a feature file with the right instructions for the specific driver. The mapping table may link the vocabulary used in the source code specific to each driver to the parameters of the dimming information in order to obtain a universal tool to create feature files for various drivers.

The following Step S5 is to replace the previous driver 10 by the new replacement driver 100. This step may be performed by a qualified person, like the maintenance specialist 20, as it may imply accessing the inside of the housing of the luminaire and disconnecting and reconnecting, potentially dangerous, electrical connections.

The final step S6 is to configure the replacement driver using the created feature file. In particular the feature file is transferred, transmitted, written using for instance near field communication (NFC) to the replacement driver. Other wired or wireless transfer alternatives may also be used. When a user approaches the NFC peripheral interface 40 to the NFC interface of the driver 100, the replacement driver 100 is thus programmed to operate under the desired dimming information and ready to be exchanged with the faulty driver 10 for further use in the serviced luminaire.

It is here noted that the step S5 of replacing the previous driver by a replacement driver may be split in two steps of first removing the previous driver and second installing the replacement driver. In addition these two steps may be performed prior or after any of the other steps S1-S4, S6 depending on circumstances and as obvious to a skilled person. For instance a maintenance specialist may first remove the old driver in the luminaire, program the replacement driver (new driver) on the ground and then install the new driver in the luminaire, or remove the old one, install the new one and then program the new one among other possibilities. According to another example one could even first program the new driver, then remove the old driver and next install the new one.

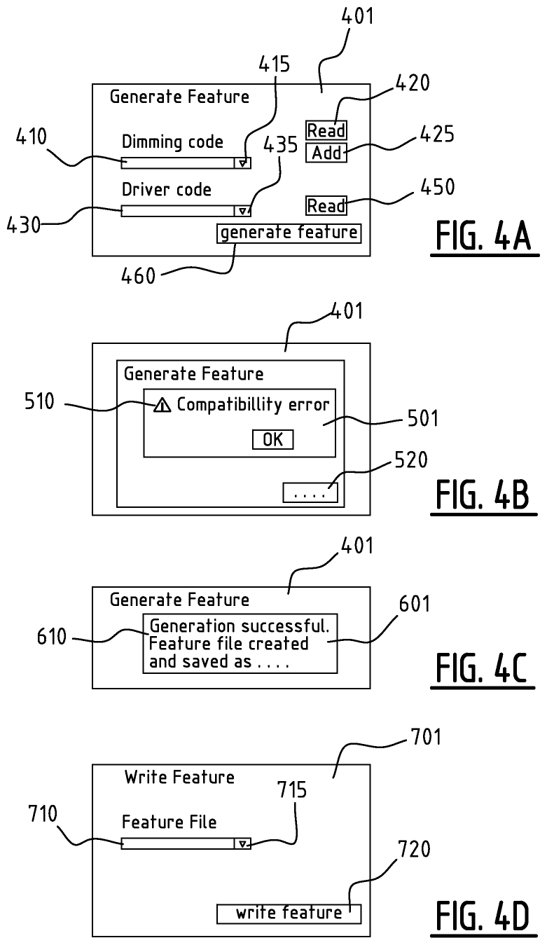

As illustrated further in FIGS. 4A to 4D showing several screen views, a computer program comprising instructions is used to cause the maintenance system 1000 comprising the replacement driver 100 and the computing means 30 to execute the steps of the maintenance method described above.

First a window 401 as in FIG. 4A may open on a graphical interface requesting first a dimming code 410. A dimming code 410 may be either selected from a scrolling menu 415 or retrieved by clicking on a “read” button 420 activating a peripheral interface 40 to read the dimming code. An “Add” button 425 may enable the user to add a new dimming code 410, in case a new dimming information is desired. This functionality may open a further interface (not shown here) for customizing dimming information.

In the same window 401 identification information may be requested in the form of a driver code 430. The driver code 430 may be entered either via a scrolling menu 435 or retrieved by clicking on a “read” button 450, activating a peripheral interface 40-60 to read the driver code 430, for instance by NFC via the NFC peripheral 40. When using NFC, the user 20 approaches the NFC peripheral interface 40 to the driver 100 such that the driver code 430 is retrieved automatically.

When both fields of the dimming code 410 and driver code 430 have been filled (Steps S1 and S2), the user is asked to validate a “create feature file” button 460. If the dimming code 410 and driver code 430 are not compatible with each other, an error window 501 as illustrated in FIG. 4B will then pop up with a message 510 indicating an error in the result of the incompatibility test of step S3. Upon validating the error message 510 using a validating button 520, the first window 401 of steps S1 and S2 is presented again, to change either the dimming code 410 and/or the driver code 430. If the new combination of dimming code 410 and driver code 430 is compatible, the feature file is generated as illustrated on FIG. 4C (step S4). A new pop up windows 601 indicates a message 610 that the generation was successful as well as the name and saving location of the newly generated feature file.

Finally, in a new window 701 illustrated in FIG. 4D, the user is requested to retrieve the generated feature file 710 using a scrolling menu 715 and/or a search tool (not represented). After validating the “Write feature” button 720, a transfer of the feature file to the driver is activated (step S5). In particular after pressing the “write feature” button 720, when a user 20 approaches e.g. the NFC peripheral interface 40 to the driver 100, the feature file is written into the driver 100, and the driver 100 is programmed to operate under the desired dimming information.

The above described computer program may further be stored on a computer readable medium.

Although disclosed here for the purpose of servicing a luminaire having a faulty driver, the concept of the present method can be broadened to encompass situations beyond the normal use of the luminaire relating for instance to failure situations, surveillance and monitoring in general. A similar method and similar program would be used as a common way of monitoring various kinds of programmable components such as drivers independent of the brand and model. Indeed, a programmable component may be reprogrammed using a created feature file without replacing the programmable component. This may be useful if desired operational information for a luminaire has changed, e.g. because the environment around the luminaire has changed.

In addition although not represented here, the possibility of updating the program to a more recent version may be offered to the user in the graphical interface 401 and/or 701.

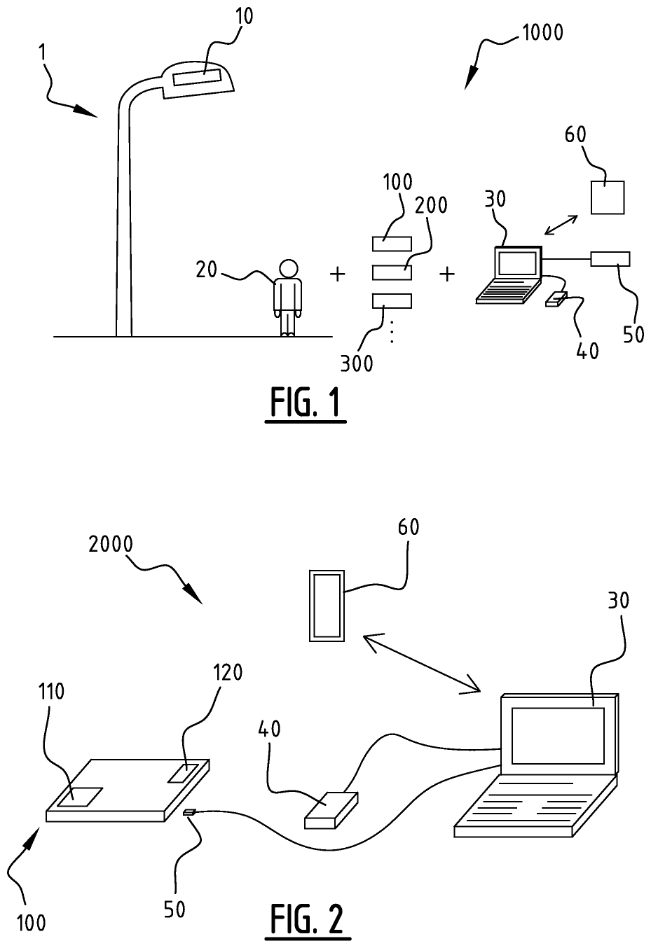

FIG. 2 shows a configuration situation in which an exemplary embodiment of the configuration method is of particular interest. A system 2000 may comprise a driver 100 and computing means 30 with peripherals 40-60. A driver 100 for a luminaire may be provided with a label 110 comprising among other at least one of the name, the model, the brand, the main characteristics of the driver. A QR code or a bar code may also be present on the label 110. Alternatively a label such as 110 may be provided on the luminaire The driver 100 may further be provided with a near field communication (NFC) interface 120 for reading-writing information from/into the driver 100. Among the possible peripherals could be an NFC peripheral interface 40, a cabling interface 50 to interact with drivers via physical wiring and plugging, a bar code reading interface, a tablet or a mobile 60 for scanning QR codes. The computing means self may be comprised in a general computer, a laptop, a tablet or a mobile. This list is not exclusive and is a mere illustration of possibilities a skilled person would understand as suitable for the present application.

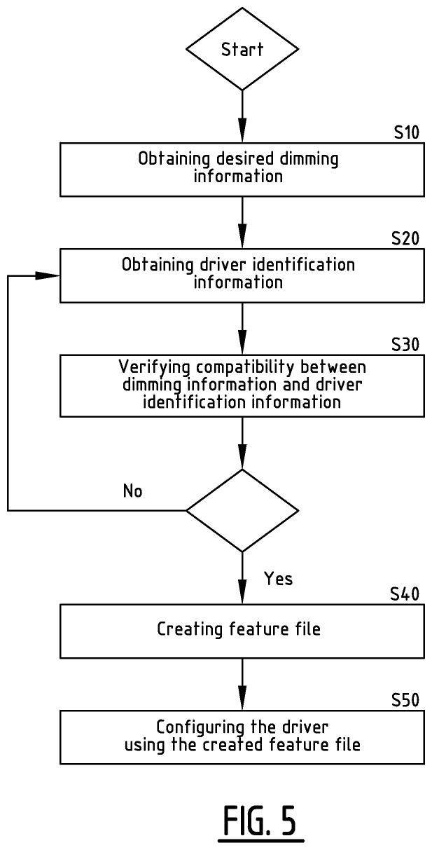

FIG. 5 shows a configuration situation in which an exemplary embodiment of the method of the present application is of particular interest. During manufacturing, a luminaire comprising a driver 100 is to be configured to a particular use using computing means 30 with several peripherals 40, 50 and 60. The same reference numbers as used for the maintenance situation apply here as well.

The present method for configuring the luminaire in that situation will now be described with reference to the flowchart of FIG. 5. The method is computer-implemented on the computing means 30 connected to peripheral interfaces 40, 50 and 60. Upon starting up the configuration process of the driver, the first step S10 is to obtain the desired dimming information of the luminaire assembly. The dimming information may be defined by a dimming code representative for at least a drive current and a type of dimming For instance the dimming code may stand for a feature table comprising at least a drive current and a type of dimming for simple cases. The drive current may be the maximum output current used to drive a light source, typically a plurality of LEDs of the luminaire assembly. The type of dimming can be e.g. amplitude dimming relating a voltage to the light output, scheduling dimming where several dimming levels are scheduled during the day, DALI, Bipower mode having two dimming levels 0-10V, no dimming mode where the user chooses to operate without dimming, etc. The dimming code may further be representative for at least an additional parameter selected from dimming information, such as a dimming profile over time, a thermal protection feature and a constant lumen output (CLO) feature, a geographical information, further functionalities information. For example, the dimming code may indicate whether a thermal protection for protecting the LEDs from overheating is present, whether a CLO function is present, a type of CLO defined by a value of a start current in percentage and a maximum amount of time before full current, a dimming percentage in function of the time of the day, a dimming percentage in function of a sensed value (e.g. sensed light, sensed movement, etc.), dimming current levels and dimming starting times for scheduling dimming, an initial dimming level, a daylight saving time, a midnight shift information based on a country code, a time zone information, a latitude information, a longitude information, a time base dimming information relating the time elapsed and the light output, a sensor override information for overriding a photocell sensor on the basis of another information like the presence of a user, a light colour temperature output, etc. By desired dimming information is referred to information related to the future dimming characteristics intended for the luminaire in terms at least of drive current and type of dimming The dimming information may be known from beforehand and manually entered in the form of a code of a limited number of digits by the maintenance specialist. During step S1, data concerning the dimming information is thus received.

The following step S20 is to obtain the identification information of the programmable driver of the luminaire. The identification information may be actually defined by a driver code representative for the technical characteristics of the driver, preferably the name and/or brand and/or model of the driver. The step of obtaining the identification information is done preferably by reading the identification information by NFC on the driver. The NFC peripheral interface 40 is brought in near proximity of the NFC interface 120 on the driver 100 to read into the driver 100 and transmit to the computing means 30 the data concerning the identification information of the driver 100. During step S20, data concerning the identification information is thus received. However during the manufacturing process the wrong driver may have been selected. The following step S30 is then to verify the compatibility between the identification information and the dimming information. In this way a safeguard against an improper matching between the intended use and the chosen driver is introduced. In case the result of the compatibility check is negative, an error message indicating an incompatibility is shown to the user and the method loops back to step S20 by requesting new identification information of another driver. In this way the driver may be changed and replaced by another suitable one. If the result of the compatibility test is positive and the dimming information and identification information are compatible, the method proceeds further to step 40.

The following step S40 is then to create a feature file based on the desired dimming information and the identification information. The feature file comprises programming instructions for programming the programmable driver to obtain the desired dimming information. A mapping table may be used between the dimming information and the programming parameters of programmable drivers defined by their respective identification information. In this manner, the desired dimming information for the luminaire assembly may be translated into a language specific to a specific driver, and can be used to generate a feature file with the right instructions for the specific driver. The mapping table may link the vocabulary used in the source code specific to each driver to the parameters of the dimming information in order to obtain a universal tool to create feature files for various drivers.

The final step S50 is to configure the driver using the created feature file. In particular the feature file may be transferred, transmitted, written using for instance near field communication (NFC) onto the driver 100. Other wired or wireless transfer alternatives may also used. When a user approaches the NFC peripheral interface 40 to the NFC interface 120 of the driver 100, the program is loaded into the driver and the driver is then programmed to operate under the desired dimming information and ready for further use in the luminaire.

The same software as described in FIGS. 4A-4D is used to perform the steps of the method described in FIG. 5.

In the examples of FIGS. 1-5 the programmable component is a driver for driving a light source. However, as explained in the summary, other programmable components such as a sensor, a communications means, a controller, a driver for powering a load which is not a light source, a human interface device, etc. may replaced and programmed in a similar way using any suitable operational information.

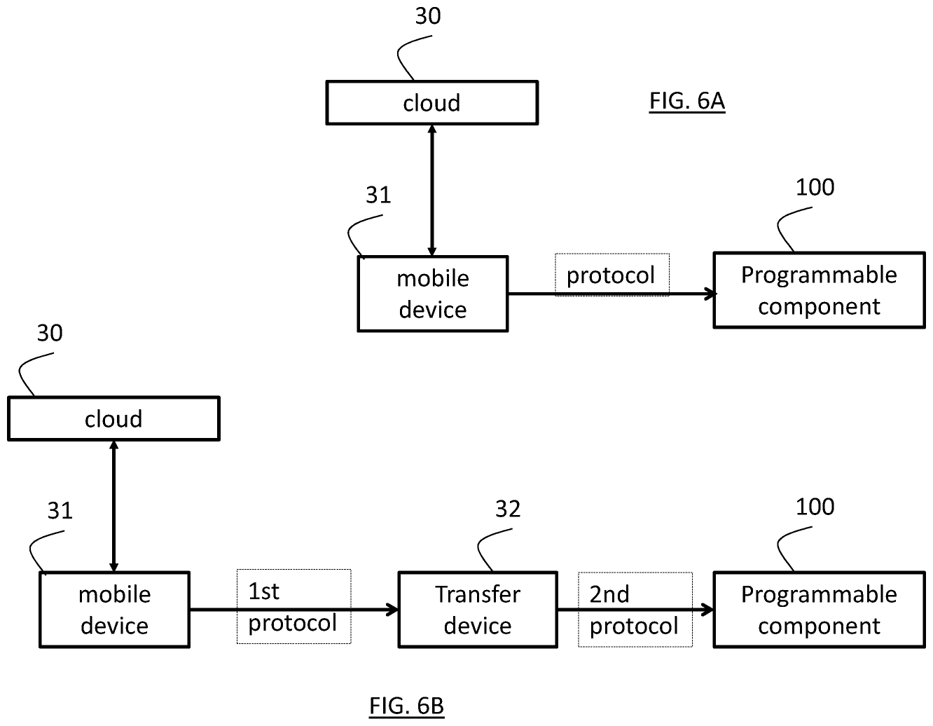

FIGS. 6A and 6B illustrate possible embodiments for transferring the created feature file to a replacement component 100. The creating of the feature file is done by a computer means based on the identification information corresponding with the programmable replacement component 100 and the desired operational information. According to an exemplary embodiment, the desired operational information comprises any one or more of the following: a dimming information, a protocol type, e.g. a type of communication protocol used by the programmable component 100, a power related parameter of the programmable component 100, a control parameter, a control profile. In an exemplary embodiment the programmable component 100 is a programmable sensor having a memory in which one or more control parameters are stored, e.g. during assembly of the luminaire in the factory, wherein the one or more control parameters are ensuring a good operation of the sensor within the luminaire assembly. The one or more control parameters may comprise any of the exemplary control parameters discussed above in the summary.

The method uses a computer means comprising a remote server 30 indicated as the “cloud” in FIGS. 6A and 6B. A mobile device 31 communicates with the remote server 30. For example, the remote server 30 may be connectable via a mobile phone application to the mobile device 31, e.g. a smart phone or a tablet. The mobile device 31 may be used to obtain the identification information of the replacement programmable component 100 and of the desired operational information. For example the mobile device 31 may read out the identification information and/or of the desired operational information using any one of the method steps disclosed in the summary. Based thereon the feature file is created e.g. by the remote server 30 and/or by the mobile device 31. It is noted that the feature file may be created by a single processor or may be created in a distributed manner. Also, for creating the feature file use may be made of data stored in the remote server.

In some embodiments, the created feature file is transferred directly from the mobile device 31 to the replacement programmable component 100, see FIG. 6A.

In other embodiments, the created feature file is transferred from the mobile device 31, to a transfer device 32, e.g. a brand-specific mobile device, and next from the transfer device 32 to the replacement programmable component 100. The transfer from the mobile device 31 to the transfer device 32 may use a first protocol, e.g. Bluetooth, and the transfer from the transfer device 32 to the replacement programmable component 100 may use a second protocol, e.g. NFC.

Optionally, the feature file may be encrypted, e.g. by the remote server 30 or by the mobile device 31. For example, the feature file may be created on the remote server 30 and encrypted before sending it to the mobile device 31. The decryption may take place e.g. in the replacement programmable component 100 or in the transfer device 32.

Whilst the principles of the invention have been set out above in connection with specific embodiments, it is understood that this description is merely made by way of example and not as a limitation of the scope of protection which is determined by the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A maintenance method for replacing a component in a luminaire assembly, said method comprising:
obtaining desired operational information of the luminaire assembly;
obtaining identification information of a replacement programmable component;
creating a feature file based on the desired operational information and the component identification information, said feature file comprising programming instructions for programming the replacement programmable component to obtain the desired operation as defined by the desired operational information;
replacing the previous component by the replacement programmable component; and
configuring the replacement programmable component using the created feature file.

37. The method according to claim 36, wherein the programmable component is a driver, the identification information being preferably defined by a driver code representative for the technical characteristics of the driver, more preferably the name and/or brand and/or model of the driver.

38. The method according to claim 36, wherein the desired operational information comprises desired dimming information.

39. The method according to claim 38, wherein the obtaining of desired dimming information comprises obtaining a dimming code representative for at least a drive current and a type of dimming, the dimming code being preferably further representative for at least an additional parameter selected from: a dimming profile over time, a thermal protection feature, a constant lumen output, a CLO feature, geographical information, and additional functionalities information.

40. The method according to claim 37, wherein creating a feature file based on the desired dimming information and the identification information comprises the step of using a mapping table between the dimming information and programming parameters of programmable drivers defined by their respective identification information.

41. The method according to claim 36, further comprising the additional step of verifying the compatibility between the identification information and the desired operational information, wherein preferably the additional step of verifying the compatibility comprises verifying if the type of dimming of the desired dimming information is supported by the programmable component corresponding with the identification information.

42. The method according to claim 36, wherein obtaining the identification information comprises reading the identification information using near field communication, NFC on the replacement programmable component, preferably on the replacement driver and/or wherein obtaining the identification information comprises entering the identification information by an operator.

43. The method according to claim 36, wherein obtaining the desired operational information of the luminaire assembly comprises machine reading a QR code or a bar code, and/or wherein obtaining the desired operational information of the luminaire assembly comprises reading an operational information using near field communication, NFC, and/or wherein obtaining the desired operational information of the luminaire assembly comprises entering an operational information by an operator.

44. The method according to claim 36, wherein the step of configuring the replacement programmable component using the created feature file comprises transferring the feature file to the replacement programmable component using near field communication, NFC and/or Bluetooth, and/or wherein the step of configuring the replacement programmable component using the created feature file comprises transferring the created feature file using a first protocol to a transfer device and transferring the created feature file using a second protocol different from the first protocol from the transfer device to the programmable component.

45. The method according to claim 36, wherein the programmable component is any one of the following: a driver, a controller, a sensor, a communication device, and a human-interface device, and/or wherein the desired operational information comprises any one or more of the following: a protocol type, e.g. a type of communication protocol used by the programmable component, a power related parameter, a control parameter, and a control profile.

46. The method according to claim 36, further comprising a step of encrypting the created feature file, transferring the encrypted feature file, and decrypting the encrypted feature file.

47. A computer-implemented method for configuring a luminaire assembly comprising a programmable component, comprising:
obtaining a desired operational information for the luminaire assembly;
obtaining the identification information of the programmable component;
creating a feature file based on the desired operational information and the identification information, said file comprising programming instructions for programming the programmable component to obtain the desired operation defined by the desired operational information; and
configuring the programmable component using the created feature file.

48. The method according to claim 47, wherein the programmable component is a driver, and/or wherein the desired operational information comprises desired dimming information, the identification information being preferably defined by a driver code representative for the technical characteristics of the driver, more preferably the name and/or brand and/or model of the driver.

49. The method according to claim 48, wherein obtaining desired dimming information comprises obtaining a dimming code representative for at least a drive current and a type of dimming, the dimming code being preferably further representative for at least an additional parameter selected from: a dimming profile over time, a thermal protection feature, a constant lumen output (CLO) feature, geographical information, and additional functionalities information.

50. The method according to claim 47, wherein creating a feature file based on the desired operational information and the identification information comprises the step of using a mapping table between the operational information and programming parameters of programmable components defined by their respective identification information.

51. The method according to claim 47, further comprising the additional step of verifying the compatibility between the identification information and the desired operational information.

52. The method according to claim 47, wherein obtaining the identification information comprises reading the identification information using near field communication device, NFC, on the component, and/or wherein obtaining the identification information comprises entering the identification information by an operator.

53. The method according to claim 47, wherein obtaining the desired operational information of the luminaire assembly comprises machine reading a QR code or a bar code, and/or wherein obtaining the desired operational information of the luminaire assembly comprises reading an operational information using near field communication, NFC, and/or wherein obtaining the desired operational information of the luminaire assembly comprises entering an operational information by an operator, and/or wherein the step of configuring the programmable component using the created feature file comprises transferring the feature file to the component using near field communication and/or Bluetooth.

54. A computer-implemented method for configuring a luminaire assembly comprising a programmable component, comprising the steps of:
obtaining desired operational information of the luminaire assembly;
obtaining identification information of a replacement programmable component;
verifying the compatibility between the identification information and the desired operational information;
creating a feature file based on the desired operational information and the component identification information, said feature file comprising programming instructions for programming the replacement programmable component to obtain the desired operation as defined by the desired operational information; and
configuring the replacement programmable component using the created feature file.

55. The method according to claim 54, wherein the desired operational information comprises desired dimming information and wherein the step of verifying the compatibility comprises verifying if a type of dimming of the desired dimming information is supported by the programmable component corresponding with the identification information.
